(19) United States
(12) Patent Application Publication
(10) Pub. No.: US 2013/0056482 A1
(43) Pub. Date: Mar. 7, 2013

(54) CONTAINER WITH PRINTED SURFACE CONTOUR AND PRINTING METHOD

(71) Applicants: Konrad Senn, Regensburg (DE); Andreas Kraus, Regensburg (DE); Alexander Schau, Regensburg (DE); Andreas Sonnauer, Worth (DE)

(72) Inventors: Konrad Senn, Regensburg (DE); Andreas Kraus, Regensburg (DE); Alexander Schau, Regensburg (DE); Andreas Sonnauer, Worth (DE)

(73) Assignee: KRONES AG, Neutraubling (DE)

(21) Appl. No.: 13/600,507

(22) Filed: Aug. 31, 2012

(30) Foreign Application Priority Data
Sep. 1, 2011 (DE) 10 2011 082 011.6

(51) Int. Cl. B65D 1/40; G06K 15/02; B65D 25/34

(52) U.S. Cl. 220/674; 358/1.9

(57) ABSTRACT

A printed container for packing, in particular for packing products for sales purposes, in particular beverages, and a corresponding printing method. The container includes at least one lateral wall section in which a relief-like surface contour is embodied for decoration and/or marking purposes. By the relief-like surface contour being selectively printed, in cooperation of the relief contour with the imprint, an optical impression of the container can be improved, and/or a synergetic effect can be achieved with the haptics of the surface contour.

### CROSS-REFERENCE TO RELATED APPLICATION

The present application claims the benefit of priority of German Application No. 102011082011.6, filed Sep. 1, 2011. The entire text of the priority application is incorporated herein by reference in its entirety.

### FIELD OF THE DISCLOSURE

The disclosure relates generally to a container for packing products, such as beverages, and to a method of printing the container, and more particularly, to a container having a relief-like surface contour having printing thereon, and a method for printing on a relief-like surface contour of such a container.

### BACKGROUND DESCRIPTION OF THE RELATED ART

It is well-known to provide packaging containers for products, for example beverages, sanitary products and the like, with relief-like surface contours in the lateral wall area to achieve a high-quality product presentation and/or improved handling. In particular in plastic containers, this can contribute to a stabilization of the container wall and to an enhancement of the appearance and the surface feel of the container. One can usually thus achieve an added value of the container by a relief-like surface structure, for example an ornamental structure.

It is further known that containers are printed to provide them with a label and/or a decoration, for example with characters, logos, patterns and color gradients. In this respect, WO 03/002349 A2, for example, describes a method of ink-jet printing onto essentially cylindrical container side walls. It is equally known from DE 197 53 816 C2 to imitate the impression of a natural malachite stone or similar materials by an imprint on a flat container surface. From DE 2 404 433 A1, a printing method is furthermore known wherein the side wall of a plastic container is already printed in the manufacturing mold by means of lateral nozzles. However, this restricts design flexibility and print quality in an undesired way.

For all these printing methods, only an imprint on smooth surfaces of the container side wall is described.

### SUMMARY OF THE DISCLOSURE

However, it would be desirable to further increase the added value of product packages, in particular those of plastics, compared to the known method. Here, an increase in value with minimum material consumption and maximum design flexibility with respect to the container shapes and imprints would be particularly advantageous.

The set object is achieved with a container for packing, in particular packing for sales purposes, products, in particular beverages, according to claim 1. By a relief-like surface contour being selectively printed in a lateral wall section for decoration and/or marking purposes, and/or the lateral wall section around the relief-like surface contour being printed, an optically advantageous impression, which is otherwise restricted to contrasts by shadowing and/or light reflections, can be purposefully improved by the imprint. Simultaneously, the container wall can be stiffened for a predetermined mechanical stability under load. By a selective imprint on the relief-like surface contour, a haptic sensation can be also reinforced. Thus, the quality rating of the container can be purposefully improved by the interaction of the surface feel given by the relief-like surface structure and a selective printing. A decorating contour is, for example, an ornamental structure, a contour for marking purposes is, for example, a legend or a level indicator. The imprint can be designed such that it selectively changes a gloss level of the printed area, for example from dull to glossy or vice-versa, and/or that it purposefully changes the surface structure, for example the roughness. By this, decorating effects as well as markings can be produced. This is, for example, particularly advantageous for containers for beverages, cosmetic products, cleansing agents, and the like.

A relief-like surface contour is defined as a three-dimensional structure which stands out against a surrounding wall section by elevations and/or depressions that can be produced purposefully and reproducibly. Such relief-like surface contours preferably comprise contours in the macroscopic range that can be sensed and also recognized, i.e. spatially resolved, by the human eye at the viewing distances common for the use or sales (i.e., retail display) of the containers.

An imprint around the relief-like surface contour is particularly effective in raised surface contours, for example legends, to define them by colors with respect to the printed wall section and thus emphasize them. The relief-like surface contour could additionally be printed itself. However, a variant in which the material of the corresponding wall section is already colored in a suited way, so that one only has to print around the relief-like surface contour, is particularly advantageous. An imprint around a transparent relief-like surface contour would also be possible. The imprint could then advantageously interact with the color of the product for sales and serve as level indicator or the like when it is later used. It is also conceivable to only print partial sections of the wall section adjacent to the surface contour, for example only regions underneath a legend, to obtain a shadow-like effect, or above a legend, to imitate a lightning situation. Regions within and/or outside the relief-like surface contour can be printed according to the disclosure. Such imprints can also be particularly effectively realized around raised structures by means of ink jet printing.

Preferably, an imprint with a brightness contrast and/or color contrast following the course of the relief-like surface contour is provided. This makes it possible to purposefully reinforce the effect of a brightness gradient, shadowing or light reflection predetermined or indicated by the course of the surface contour. In particular, a plastic impression predetermined by the course of the surface contour can be optically reinforced. As an alternative or in addition, limits, gradations or transitions of areas with different surface roughness, different gloss levels and/or coefficients of friction following the course of the relief-like surface contour could also be provided.

In a particularly advantageous embodiment of the container according to the disclosure, the relief-like surface contour comprises at least one elevation and/or depression which extends in a curved and/or oblique manner in a two-dimensional projection of the lateral wall section, in particular in a cylindrical projection, around the vertical axis of the container. Such surface contours stand particularly effectively out against the geometric basic shape of the container. Thus, a particularly high increase in value can be achieved by the contour and the selective printing of the corresponding lateral wall section.

The two-dimensional projection here approximately corresponds to the development of a printable flat surface. A cylindrical projection is suited for most of the common basic container shapes, as it is known, for example, from geographical map projections as equal-area cylindrical projection, orthomorphic cylindrical projection, or as equidistant cylindrical projection. In these projections, preferably at least one section of the relief-like surface structure extends in an oblique and/or curved way. However, other projection methods for printing the surface contour are also basically conceivable.

The projection according to the present disclosure, however, is not in particular restricted to cylindrical container shapes. For example, shaped bottles with a not rotationally symmetric cross-section can also be represented as two-dimensional projection.

The two-dimensional projection defines print areas on and/or in the region of the relief-like surface contour and forms the basis for printing instructions for printing the container side wall.

Preferably, the relief-like surface contour is further designed to stabilize the container, in particular for a radial and/or axial stabilization. By this, optical and haptic enhancements of the container and an improvement of mechanical strength can be simultaneously achieved. A radial stabilization is defined herein as a stabilization that counteracts forces in particular laterally acting in the direction of the vertical axis of the container, for example when the container is gripped. Axial stabilizations can, for example, improve the resistance of the container against superimposed loads.

The container preferably includes plastics, in particular of PET or HDPE. With these container materials, optical and haptic enhancements by means of printed relief-like surface contours have a particularly advantageous effect. In particular, optical and haptic impressions possibly sensed to be disadvantageous compared to glass bottles can be improved. Printing glass bottles with relief-like surface structures is also possible using the methods of the present disclosure.

The container is preferably manufactured by stretch-blow molding. In such containers, relief-like surface contours can be produced in particularly versatile and simple ways. The containers can also be made by using corresponding preforms of a material particularly suited for the imprint, for example in a color particularly suited for the background of the imprint. By simply exchanging the preforms, opaque or transparent containers can be provided. Thus, a synergy of appearance and surface feeling of the container can be particularly well achieved with blow-molded containers. Individual printed or non-printed wall sections can additionally differ with respect to their surface roughness, for example to realize glossy and dull wall sections, or clear and light scattering wall sections. Basically, the methods of the present disclosure can also be advantageously applied to containers manufactured by means of injection-blow molding or extrusion blowing.

Preferably, the container is in this case made of a preform comprising at least two differently colored wall sections. Already by blow-molding the container, a multicolored container wall can thus be provided. Thus, the color of a suitably colored wall section can serve as a background for the imprint according to the present disclosure. This facilitates the subsequent printing of the lateral wall sections and can furthermore improve the print quality or the appearance of the print. This permits printing without additional subprinting with a background color. Differently colored is defined herein as a configuration in which the wall sections only or additionally differ with respect to their transparency, for example one transparent and one opaque wall section. The imprint according to the present disclosure, however, generally also improves containers made of single-color or continuously transparent preforms.

Preferably, a print image is seamlessly resumed in the hue of one of the differently colored wall sections in at least the second wall section. By this, a homogenous appearance can be achieved even in complicated relief-like surface structures with comparably little efforts for printing. In other words, the print image takes up the hue and the shape or the contour of an adjacent, suitably colored wall section to form a decoration, marking, or the like together with it.

In containers with at least two wall sections consisting of basic materials with different optical properties, for example with a different coloration, transparency, light scattering, and the like, particularly advantageous effects can be achieved by an imprint that seamlessly follows an adjacent wall section even in a case where the container does not comprise any relief-like surface structures or the imprint according to the present disclosure is not provided in areas with relief-like surface structures. Thus, an increase in the container's value can also be achieved by printing regular and/or smooth surfaces, for example essentially smooth cylindrical side wall areas.

For this, a hue of a first wall area is preferably seamlessly resumed by the imprint on a second wall area which is made of a material of a different hue. In the second wall area, the hue of the imprint can then vary as desired, starting from the hue of the first wall area and at a suited distance from the latter, for example as gradual or smooth transition into the hue of the material of the second wall area. Thereby, raised or depressed three-dimensional structures can be particularly effectively imitated two-dimensionally with minor efforts, for example shadowing, or the like.

By the smooth transition of the imprint into a correspondingly colored basic material of an adjacent wall section, one can minimize the overall area to be printed without having to accept a disadvantageous optical impression in the transitional area between the imprint and the adjacent wall area with corresponding coloration. By a seamlessly adjoining imprint, a reflection of light and/or light scattering of an adjacent wall area could also be imitated, for frosted, i.e. diffusely scattered wall areas. Thus, a separate technical problem can be solved by providing, at usual viewing distances, an optically seamless transition of the imprint into the adjacent wall area just in areas without relief-like structures in the sense of the above-mentioned definition. Nevertheless, such an imprint is particularly effective in areas with relief-like surface structures.

Preferably, the lateral wall section consists of a pigmented basic material. One can particularly easily print onto such wall sections, in particular without previously printing a color underneath the selectively printed surface. A pigmented base material is here defined as a material which generates a suited contrast to the imprint by a color and/or a pigment, so that a subprint with a separate color layer becomes dispensable. For example, an otherwise colored or else colorless base material could be brightened by a white pigmenting to simplify the selective imprint. However, in general a bright imprint on a comparably darker ground is also possible. Equally, transparent and/or colorless wall sections can be printed, for example if the print is to be adapted to the color of the product.

In a particularly advantageous embodiment, the container furthermore comprises at least one contrasting wall section which consists of a base material with a color and/or shade of gray and/or transparency differing from those of the lateral wall section. By such a combination of the contrasting wall section with the selective imprint, a particularly advantageous optical effect can be achieved. For example, a relief-like and/or ornamental structure predetermined by the contrasting wall section can be resumed by the selective imprint or be embodied in a complementary shape or color in the sense of a negative.

Preferably, the lateral wall section is selectively printed with the color and/or shade of gray of the base material of the contrasting wall section. By this, a particularly advantageous optical effect can be achieved. Equally, material consumption for printing can be reduced, for example, when the contrasting wall section does not have to be printed due to the color matching the lateral wall area. The contrasting wall section, however, can also be printed to further increase design flexibility.

In a particularly advantageous embodiment, the relief-like surface structure comprises a marking as a level indicator or the like. By this, an optical and/or haptic enhancement can be combined with an improved handling of the container in use. In particular by a selective print, a marking as a level indicator or as an indicator of the remaining quantity of the product can be particularly effectively combined with the color of the product, and/or a particularly good contrast to the filled-in product can be generated.

The relief-like surface structure preferably comprises a legend and/or a symbol and/or a logo. Characteristic features can be particularly effectively emphasized on the container thereby. For example, the perceptibility of a legend, the signal effect of a symbol, and the recognition value of a logo can be purposefully reinforced by the combination of appearance and haptics.

In a particularly advantageous embodiment of the container according to the present disclosure, the selective imprint on the lateral wall section is an ink jet print. Such a print is particularly desirable with respect to the color design and the flexible adaptation to different containers and products. Color transitions and a reinforcement of gloss effects and/or shadowing can be particularly well imitated and/or reinforced by the ink jet print. However, printing methods according to the screen printing or pad printing principle are also conceivable.

The selective imprint preferably comprises individually adaptable print areas. This permits the production of containers of particularly high-quality. The individually adaptable regions can contain, for example, images, bar codes, dedications, messages and the like. Thus, certain areas of the container can be particularly effectively emphasized and/or particularly well read.

The set object is furthermore achieved with a method of printing the container according to the present disclosure, including the steps of:

a) transforming the relief-like surface contour into a two-dimensional projection; and

b) preparing a printing instruction for selectively printing the relief-like surface contour on the basis of the two-dimensional projection.

This permits even for relief-like surface contours with strictly mathematically not developable surfaces to position the container and/or a printing device in a three-dimensional space to purposefully and reproducibly apply an imprint in the region of the relief-like surface contour.

In step a), at least one mathematically not developable surface of the relief-like surface contour is preferably defined as a surface to be printed in the two-dimensional projection. Printing instructions for conventional printers for printing flat surfaces can be thereby calculated, and suited relative positions between the relief-like surface contour and the printer can be moved to during printing.

Preferably, the two-dimensional projection is a cylindrical projection or a prism projection, in particular a projection on the basis of an equal-area cylindrical projection, an orthomorphic cylindrical projection, and/or an equidistant cylindrical projection. The prism projection projects the relief-like surface contour onto the side faces of a prism, where its base can be equal-sided or non-equal-sided. The equal-area cylindrical projection is, for example, a projection according to Lambert. The orthomorphic cylindrical projection is, for example, a Mercator's projection. The equidistant cylindrical projection is, for example, a so-called square flat map. However, other projections in the sense of geographic map projections and the like as well as any combinations of the mentioned projection models are also suited.

The two-dimensional projection can relate to an imaginary reference surface or base of the relief-like surface contour which extends between the highest and the lowest relief areas, for example essentially centrically between the highest elevations and depressions. This permits to obtain a high-quality print image despite inaccuracies and/or tolerances in projection and print.

A particularly advantageous variant of the method according to the present disclosure furthermore comprises the step c) of orienting the lateral wall section to a print position and printing the relief-like surface contour on the basis of the printing instruction, in particular by means of ink jet printing. This permits a particularly precise and reproducible print.

Preferably, the orienting step comprises scanning at least one area of the relief-like surface contour. Scanning can be done, for example, contactlessly by means of light scanning. This improves the allocation of the areas to be printed with respect to the printing pattern.

Advantageous embodiments of the container according to the present disclosure are represented in the drawing.

### BRIEF DESCRIPTION OF THE SEVERAL VIEWS OF THE DRAWING

FIG. 1 shows a side view of a first embodiment;

FIG. 2 shows a two-dimensional projection of the relief-like surface structure of the first embodiment;

FIG. 3 shows a side view of a second embodiment; and

FIG. 4 shows a two-dimensional projection of the relief-like surface contour of the second embodiment.

### DETAILED DESCRIPTION OF THE PREFERRED EMBODIMENTS

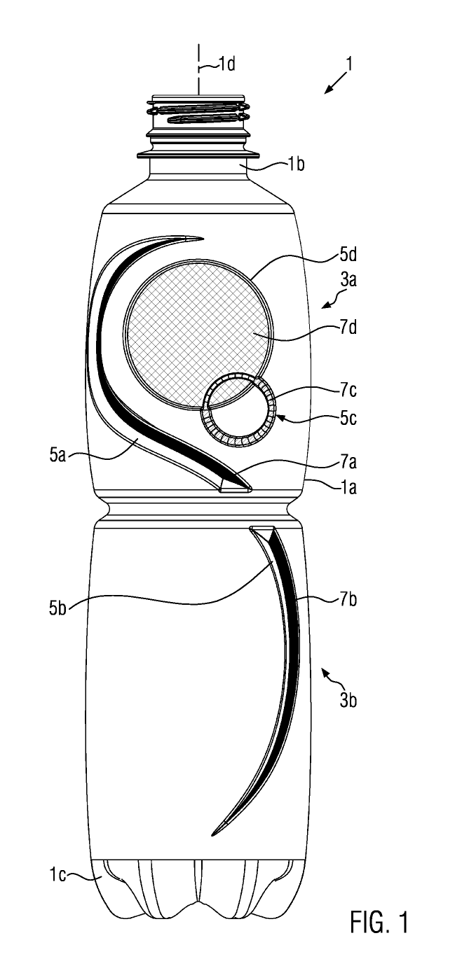

As can be seen in FIG. 1, the first exemplary embodiment 1 of the container according to the present disclosure, which is manufactured, for example, from PET or HDPE by stretch-blow molding, in a well-known manner comprises a side wall 1a, a mouth region 1b and a bottom region 1c. In the region of the side wall 1a, at least one lateral wall section 3a, 3b is provided, where in its outer surface at least one relief-like surface contour 5a to 5d is formed each. The container 1 could also include another material, for example of glass.

In the example of FIG. 1, the relief-like surface contours 5a, 5b are designed as depressions in the lateral wall sections 3a, 3b, while the relief-like surface contours 5c, 5d, are designed as elevations. However, any combinations of raised and depressed sections in a relief-like surface contour 5a to 5d are conceivable. Equally, the ornamental character of the shown surface contours 5a to 5d is only given by way of example. These could also be legends, symbols, logos, patterns, surface structures characteristic of certain materials, such as snakeskin, and the like.

In the areas of the relief-like surface contours 5a to 5d, the wall thickness of the container side wall 1a can have a thickness different from that in the areas of the lateral wall areas 3a, 3b that surround the surface contours 5a to 5d. However, this is not imperative. For example, a stabilizing effect can be achieved by means of the relief-like surface contours even with an essentially unchanged wall thickness in the region of the relief-like surface contours 5a to 5d, for example to counteract radially acting forces, for example when the container 1 is gripped.

As one can furthermore see in FIG. 1 by the blackened or shaded areas, the relief-like surface contours 5a to 5c are selectively provided with at least one imprint 7a to 7c. An imprint 7d is furthermore provided on the lateral wall area 3a within the relief-like surface contour 5d. The imprint preferably, however not imperatively, follows the course of the relief-like surface contours 5a to 5c to reinforce a contrasting effect with respect to the respective surrounding areas of the lateral wall areas 3a, 3b. For example, the imprints 7a to 7c can reinforce or synergetically supplement a brightness contrast and/or color contrast caused by shadowing, reflection and/or by the product to be filled into the container 1. Thus, a plastic effect of the relief-like surface structures 5a to 5c can be purposefully reinforced by the imprint 7a to 7c.

It is generally also possible to print around the relief-like surface contours 5a to 5d to emphasize them. The surface contours 5a to 5d themselves could be recessed in the print image. For example, one could also only print externally around the raised surface contour 5d. Printing around the contour would be particularly effective in relief-like, in particular raised surface contours in the form of trade mark legends, logos and the like, to improve the recognition value of a product or a trade mark by the container in a simple and effective manner.

Moreover, an advantageous interaction of appearance and haptics of the relief-like surface contour 5a to 5d and/or the lateral wall areas 3a, 3b adjacent to it is possible, as is, for example, indicated in the region of the surface contour 5d. Thus, one can in general achieve a value-adding effect, for example by generating a signal effect or surprising optical impressions by simulating materials and/or structures sensed to be of high value, by improving the recognition value and the like.

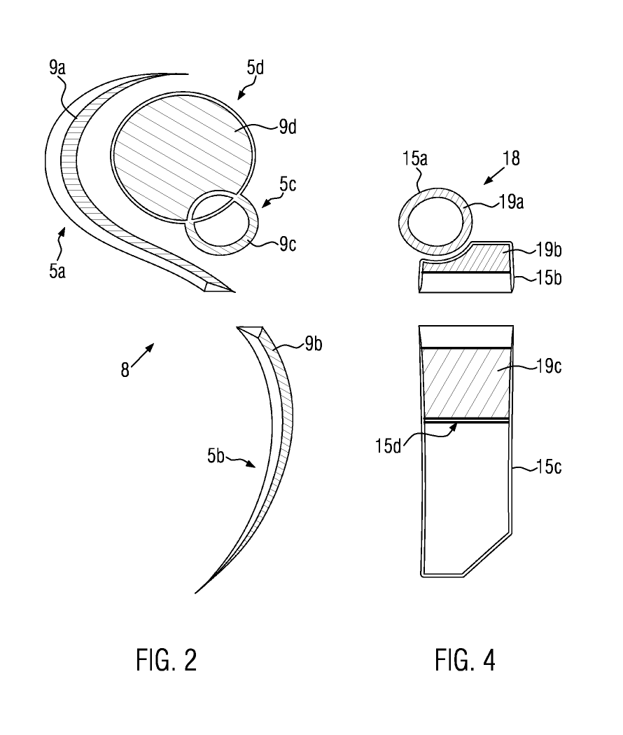

FIG. 2 shows the relief-like surface contours 5a to 5d in a two-dimensional projection 8 which is, in the shown example, a cylindrical projection around the vertical axis 1d of the container 1. In a strictly mathematical sense, the relief-like surface contour 5a to 5d according to the present disclosure is just characterized by each comprising at least one not exactly developable surface. This can also apply to the lateral wall areas 3a, 3b themselves, i.e. for surfaces adjoining the relief-like surface contours 5a to 5d, as becomes clear by the curve of the container side wall 1a in FIG. 1.

For selectively printing the lateral wall areas 3a, 3b, and in particular the relief-like surface contours 5a to 5d, these are therefore preferably transferred to the two-dimensional projection 8. Suited models for curved container cross-sections are based, for example, on known map projections. Equal-area cylindrical projection, orthomorphic cylindrical projection, and equidistant cylindrical projection, the so-called square flat map where circular areas on the three-dimensional surface also remain circular in the two-dimensional projection, as well as modifications and combinations of these models are particularly suited. Depending on the shape of the container 1, however, other two-dimensional projections 8 can also be advantageous, for example with essentially polygonal container cross-sections, a prism projection onto the respective side faces of a prism enclosing the container side wall. Depending on the container shape, those two-dimensional projections are suited that permit a conversion of the space coordinates of the imprint 7a to 7d into a two-dimensional print image or printing pattern 9a to 9d which is indicated, by way of example, by the shaded areas in FIG. 2.

The two-dimensional projection 8 can approximately correspond to a development of the container side wall 1a. The projection 8 comprises at least one print image or printing pattern 9a to 9d to provide a printing instruction for a printer (not shown). Here, it is decisive that a printing instruction for printing a relief-like surface contour 5a to 5d curved in two dimensions can be set up. Positionally accurate printing of the relief-like surface contours 5a to 5d can then be realized, for example, with the aid of a corresponding orientation of the containers 1 before printing in a three-dimensional space and subsequent tracking of the containers 1 or of the printing device, which can include, for example, ink-jet print heads and the like, corresponding to the printing instruction.

Suited technical positioning contrivances during printing are, for example, optical sensors, such as laser scanners, camera systems, mechanical stops, for example surfaces integrated in the container wall, depressions or grooves, mechanical scanning of edges of the container surface, and/or the identification of contrasts, color transitions and the like in case of colored and/or opaque containers 1.

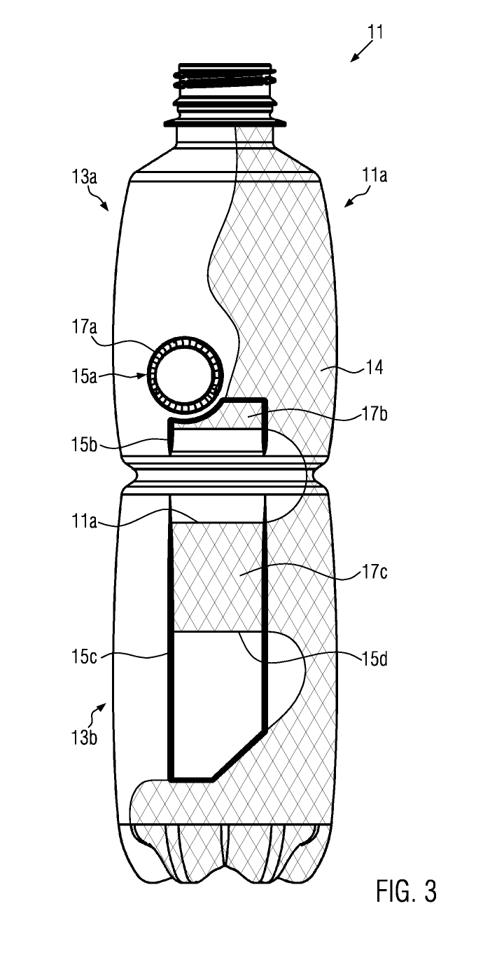

Particularly advantageous is the second embodiment 11 of the container according to the present disclosure, shown by way of example in FIG. 3, wherein the material of the lateral container wall 11a differs with respect to its optical properties in at least two separate wall areas 13a, 13b, 14, which are disposed one next to the other with respect to the container surface. As in the first embodiment 1, lateral wall areas 13a, 13b with selectively printed, relief-like surface contours 15a to 15d are provided, and in addition at least one contrasting wall area 14 is provided which differs from the lateral wall areas 13a, 13b with respect to its color and/or brightness and/or shade of gray and/or transparency. In the contrasting wall area 14, relief-like surface contours (not shown) can also be provided.

In the example, the annular surface contour 15a is raised, the other contours 15b to 15d are designed as depressions. Imprints 17a to 17c are selectively provided on the or within the relief-like surface contours 15a to 15d. This means, the relief-like surface contours 15a to 15d can be completely or partially printed and/or surrounded by the imprint 17a to 17c. Here, the imprint 17a to 17c can follow the course of the relief-like surface contour 15a to 15d, intersect and/or continue the latter.

The imprint 17a to 17c preferably comprises a hue and/or a shade of gray of the contrasting wall area 14. Thus, a shape and/or coloration predetermined by the contrasting wall area 14 can be resumed and/or supplemented in the region of the relief-like surface contours 15a to 15d in a particularly simple manner, for example by means of minor-inverted or parallel shapes, and the like. By this, optically and/or haptically attractive three-dimensional surface contours, or surface contours that functionally increase the value can be realized. One example of this is the relief-like surface contour 15d which is designed as level indicator or remaining quantity indicator.

By selectively printing the relief-like surface contours 15a to 15d, thus just in combination with at least one contrasting wall area 14, multiple optical, haptical and functional improvements can be realized in a simple manner to increase the value of the container 11 with comparably low manufacturing efforts and low material consumption. An arbitrary number of contrasting wall areas 14 can be provided whose optical properties, such as their colors, can differ as required.

The application possibilities are in particular not restricted to two-colored container side walls 11a. Differently colored side walls 11a can be easily manufactured by blow-molding from preforms (not shown) that are differently colored or pigmented in sections. Here, arbitrary regions of the preforms can consist of different material components as long as it is possible to manufacture the containers 11 by stretch-blow molding. Before blow-molding, multicolored preforms can be conditioned in a suited manner, for example by microwave radiation, independent of their coloration.

In FIG. 4, the relief-like surface contours 15a to 15d shown in FIG. 3 are represented in a two-dimensional projection 18, as it was already described for the first embodiment 1. By means of the shaded print image in the form of the printed areas 19a to 19c, one can see that the selective imprint 17a to 17c in the region of the relief-like surface contours 15a to 15d does not necessarily have to follow their course.

Other selective imprints 17a to 17c, which extend transversely, obliquely, or partially overlapping with respect to the relief-like surface contours 15a to 15d, would also be possible. Raised areas as well as depressed areas of the relief-like surface contours 15a to 15d can be printed. Equally, the imprint 17a to 17c can be provided in areas that surround raised and/or depressed structures. Digital printing by means of an ink jet, but also screen printing or pad printing are particularly suited for the imprint. For printing complex patterns and color gradients, those colors are particularly suited that can be applied with the aid of ink-jet printing.

Stretch-blow molding is particularly suited for manufacturing containers 1, 11, such as beverage bottles or containers for cosmetic products, cleansing agents and the like, with relief-like surface contours 5a to 5d, 15a to 15d, in particular also using multi-component preforms to provide the containers 11 with wall areas of different colorations and/or shades of gray. In general, plastic containers according to the disclosure can also be manufactured by injection molding and the like. Moreover, the containers 1, 11 according to the disclosure can be made of other plastics than PET and HDPE, or of glass.

The described embodiments can be arbitrarily combined in a technically reasonable manner to increase the value of containers by the combination of imprints and relief-like surface contours, and/or to improve their functionalities.

What is claimed is:

1. A container for packing comprising at least one lateral wall section in which a relief-like surface contour is embodied for at least one of decoration and marking purposes; wherein at least one of
the relief-like surface contour or the lateral wall section around the relief-like surface contour is selectively printed.

2. A container according to claim 1, wherein an imprint is provided with at least one of a brightness contrast or a color contrast following a course of the relief-like surface contour.

3. A container according to claim 1, wherein the relief-like surface contour comprises at least one elevation and/or or depression which extends in a two-dimensional projection of the lateral wall section.

4. A container according to claim 1, wherein the relief-like surface contour is further designed to stabilize the container, in particular to stabilize it radially and/or axially.

5. A container according to claim 1, wherein the container includes of plastics.

6. A container according to claim 1, wherein the container is a container manufactured by stretch-blow molding.

7. A container according to claim 6, wherein the container is blow-molded from a preform, comprising at least two differently colored wall sections.

8. A container according to claim 7, wherein a print image is resumed in the hue of one of a differently colored wall sections without transition at least in the second wall section.

9. A container according to claim 1, wherein the lateral wall section includes pigmented base material.

10. A container according to claim 1, further having at least one contrasting wall section including base material with at least one of a color, shade of gray, and transparency differing from the lateral wall section.

11. A container according to claim 10, wherein the lateral wall section is selectively printed with the at least one color or shade of gray of the base material of the contrasting wall section.

12. A container according to claim 1, wherein the relief-like surface structure comprises a marking as at least one of a level indicator, at least one legend, at least one symbol, at least one logo.

13. A container according to claim 1, wherein the selective imprint is an ink-jet imprint.

14. A container according to claim 1, wherein the selective imprint comprises individually adaptable print areas.

15. A method of printing a container having at least one lateral wall section in which a relief-life surface contour is embodied for at least one of decoration and marking purposes, including:
a) transforming the relief-like surface contour to a two-dimensional projection; and
b) preparing a printing instruction for selectively printing the relief-like surface contour on the basis of the two-dimensional projection.

16. A method according to claim 15, wherein in step a), at least one mathematically not developable surface of the relief-like surface contour is defined as a surface to be printed in the two-dimensional projection.

17. A method according to claim 15, wherein the two-dimensional projection is one of a cylindrical projection or a prism projection.

18. A method according to claim 15, further comprising c) orienting the lateral wall section into a printing position and printing the relief-like surface contour on the basis of the printing instruction.

19. A method according to claim 18, wherein the orienting step includes scanning at least one area of the relief-like surface contour.

20. A container according to claim 3, wherein the at least one elevator or depression extends in a cylindrical projection around a vertical axis of the container, in at least one of a curved or oblique manner.

21. A container according to claim 4, where in the relief-like surface contour stabilizes the container at least one of radially or axially.

22. A container according to claim 5, wherein the container includes one of PET or HDPE.

23. A method according to claim 17, wherein the two-dimensional projection is at least one of a projection on the basis of an equal-area cylindrical projection, an orthomorphic cylindrical projection, or an equidistant cylindrical projection.

24. A method according to claim 18, wherein in orienting the lateral wall section into a printing position and printing the relief-like surface contour on the basis of the printing instruction, the printing is by means of ink-jet printing.
